(19) United States
(12) Patent Application Publication
(10) Pub. No.: US 2010/0213106 A1
(43) Pub. Date: Aug. 26, 2010

(54) APPARATUS FOR SEPARATING IMPURITIES IN MASSES OF INCOHERENT MATERIALS AND RELATIVE METHOD

(75) Inventor: Antonio Dal Ben, San Biagio Di Callalta (IT)

Correspondence Address: Novak Druce + Quigg, LLP, 300 New Jersey Ave, NW, Fifth Floor, Washington, DC, 20001, US

(73) Assignee: PAL SRL, Ponte Di Piave (IT)

(21) Appl. No.: 12/738,479

(22) PCT Filed: Oct. 17, 2008
(86) PCT No.: PCT/EP2008/064022

§ 371 Date: Apr. 16, 2010

(30) Foreign Application Priority Data
Oct. 19, 2007 (IT) UD2007A000192

(51) Int. Cl. B07C 5/36

(52) U.S. Cl. 209/552

(57) ABSTRACT

A device for separating impurities in a mass of incoherent materials disposed on a slide, such as a conveyor belt. The device includes a detection device associated with the slide and a separation device. The separation device includes a plurality of deflecting elements suitable to remove, by mechanical separation action and selective discharge, a portion of incoherent material including an impurity.

### FIELD OF THE INVENTION

The present invention concerns an apparatus for separating impurities in masses of incoherent materials, able to be used for example for cleaning substantially automatically, for the purpose of recycling, from wood material, contaminating materials consisting for example of silica, stones, minerals, metals, plastic, glass or other.

The present invention is applicable in recovery plants and/or plants for the disposal and differentiation of solid urban waste.

### BACKGROUND OF THE INVENTION

A separation apparatus is known, suitable for separating contaminating impurities from a mass of incoherent material, for example wood-based. The impurities can include metal, plastic, mineral parts and suchlike.

The known apparatus comprises a conveyor belt, disposed immediately downstream of a device for unloading wood material to be subjected to cleaning operations. The known apparatus also comprises a plurality of sensors, for example of the type using magnetic induction, suitable to detect, as the belt moves, metal impurities mixed in with the incoherent wood material transported by the belt. The sensors are disposed under the conveyor belt, in a direction substantially orthogonal to the direction of movement of the conveyor belt, so as to extend their detection zone over the whole width of the conveyor belt.

The known apparatus also comprises a control unit, for example a processor or an electronic command unit, with which said sensors are connected, and a device comprising a plurality of nozzles, each associated with a predetermined sensor and suitable to emit jets of compressed air by means of a relative electro valve driven by the control unit. The device comprising the nozzles emitting compressed air is disposed under the conveyor belt.

When, as the belt is moving, a specific sensor signals the presence of a metal impurity, the control unit activates an electro valve to emit a jet of compressed air from at least one nozzle relating to the transverse portion of belt occupied by said metal impurity. In this way, the metal impurity is expelled by the jet of compressed air and directed towards a second collection element, or towards a channel to discharge the impurities.

One disadvantage of the known apparatus is that, to guarantee an efficient separation of the impurities from the wood material, the compressed air device comprises a large number of nozzles, and hence relative electro valves, thus increasing both the costs of the apparatus and also the complexity of its manufacture.

Another disadvantage is that it is necessary to emit a considerable quantity of air to ensure an efficient separation of the contaminating impurities from the incoherent material, and this entails a great waste of energy for the apparatus to function.

Another disadvantage of the known apparatus is that, due to the use of powerful jets of air, a large portion of the material to be checked, for example the wood material, is erroneously separated together with the impurities, to a percentage of even more than one in ten.

One purpose of the present invention is to achieve an apparatus for separating contaminating impurities in masses of incoherent materials, for example but not only, wood material, which reduces both the costs of manufacture and also the costs of management relating to energy consumption.

Another purpose of the present invention is to achieve an apparatus for separating contaminating impurities which allows to minimize the unwanted discards of incoherent material.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, an apparatus for separating impurities according to the present invention is associated with sliding means, such as for example a conveyor belt, suitable to move, at a predetermined or predeterminable speed, a mass of incoherent materials to be subjected to an operation to separate contaminating impurities.

The apparatus according to the present invention also comprises at least a detection device associated with the sliding means, and able to identify the position of the contaminating impurities in a predetermined portion of said mass of incoherent material transported by the sliding means.

According to a preferential solution, the detection device is an X-ray device. According to possible variants, the detection device is a TV camera or a detection device of the inductive, magnetic or thermal type or of any other suitable type.

The sliding means is suitable for feeding the mass of incoherent material towards a first collection device of selected material.

The apparatus also comprises a control and data processing unit suitable to process the detection data supplied by the detection device.

According to the invention, the apparatus comprises a separation device of the mechanical type, associated with the sliding means, and able to separate contaminating impurities from the mass of incoherent materials, directing them towards a second device for the collection of impurities.

According to a characteristic feature of the present invention, the separation device of the mechanical type comprises deflecting elements, able to be driven on command by the control unit, after having received a signal from the relative detection device, to remove, by means of a mechanical separation action and selective discharge, a portion of material that includes the impurity, thus diverting the movement of feed of the contaminating impurities detected by the detection device with respect to the mass of material to be selected.

In a preferential embodiment, the deflecting elements are mobile between a first position, or inactive position, which allows to feed the cleaned material towards the first collection device, and a second position, or active position, which determines the expulsion of the material incorporating the impurity towards the second collection device.

In another preferential embodiment, each of the deflecting elements is individually drivable by means of actuation means commanded by said control unit. Each deflecting element is driven in a manner coordinated both with the speed of advance of the sliding means, and also with the transverse position, with respect to the direction of feed, of the contaminating impurities detected by the detection device.

The mobile deflecting elements are driven to impart a mechanical impact to the portion of material that includes an impurity.

According to a variant the mobile deflecting elements are driven to cause the portion of material including the impurity to fall due to gravity.

According to a preferential embodiment of the present invention, the sliding means comprises sliding lanes, each associated with a relative deflecting element, and suitable to channel the mass of incoherent material into corresponding streams. In this way it is possible to isolate and hence separate efficiently, by means of corresponding deflecting elements, the portion of material including the contaminating impurities identified by the detection device.

According to a variant of the present invention, the separation device comprises a cylinder rotary around a substantially horizontal axis of rotation and orthogonal to the direction of feed of the incoherent material. The cylinder comprises a plurality of compartments, open on the lateral surface of the cylinder, associated with a predetermined deflecting element and suitable to collect incoherent material unloaded from the sliding means. Each deflecting element, when disposed in its second position, allows incoherent material including impurities to selectively exit towards the second collection device, from a compartment disposed, during the rotation of the cylinder, in proximity with the deflecting element. The material with impurities exits from the compartment due to the effect of gravity and of the centrifugal force imparted by the rotation of the cylinder.

On the contrary, when disposed in the first position, each deflecting element prevents incoherent material from exiting from the associated compartment and disposed in proximity with the deflecting element during the rotation of the cylinder. The selected material is therefore discharged and fed towards the first collection device when the compartment containing material without impurities is not obstructed during the rotation of the cylinder by the associated deflecting element.

The speed of rotation of the cylinder is predetermined or predeterminable according to the speed of feed of the incoherent material on the sliding means.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic lateral view of an apparatus for separating impurities in masses of incoherent materials according to the present invention in a first operating mode;

FIG. 2 is a schematic lateral view of the apparatus in FIG. 1 in a second operating mode;

FIG. 3 is a partly exploded perspective view of a detail of the apparatus in FIG. 1 in the second operating mode;

FIG. 4 is a partly exploded perspective view of the detail in FIG. 3 in the first operating mode;

FIG. 5 is a schematic lateral view of a variant of the apparatus in FIG. 1 in a first operating mode;

FIG. 6 is a schematic lateral view of the variant in FIG. 5 in a second operating mode;

FIG. 7 is a detailed schematic lateral view of a second variant of the apparatus in FIG. 1;

FIG. 8 is a schematic lateral view of a third variant of the apparatus according to the present invention.

### DETAILED DESCRIPTION OF A PREFERENTIAL FORM OF EMBODIMENT

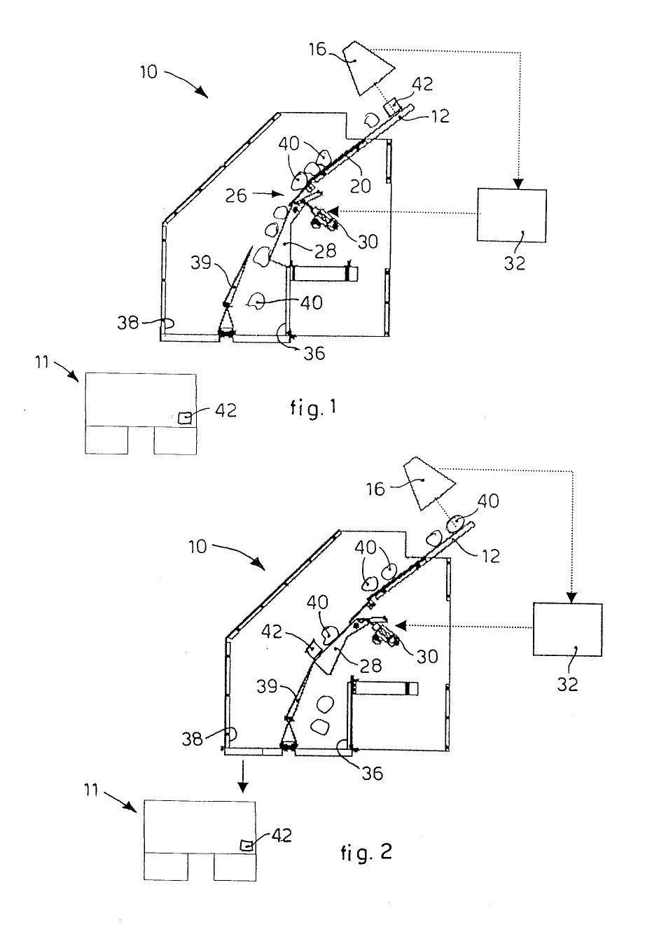

With reference to FIG. 1, an apparatus for separating impurities in masses of incoherent materials according to the present invention is able to be used, for example, to clean a mass of incoherent material, for example wood, of contaminating impurities 42 such as for example metals, stones, minerals, glass materials, plastic or other.

The apparatus 10 is associated with an entry slide 12, or a conveyor belt of a known type and not shown in the drawings, and comprises a detector 16, an inclined slide 20, disposed downstream of the entry slide 12, a separation device 26, a control and data processing unit 32, a first discharge channel 36 and a second discharge channel 38, separated from the first channel 36 by means of a wall 39.

The entry slide 12, disposed at the entrance to the apparatus 10 and fed by an unloading device for materials of a known type and not shown in the drawings, is suitable to feed a mass of wood material towards a first collection device of selected wood material of a known type and not shown in the drawings. The speed of transfer of the wood material is predetermined or predeterminable according to the shape and size of the incoherent material.

Associated with the entry slide 12 there is the detector 16, of a known type, for example an X-ray device, a TV camera, or a detector 16 of the inductive, magnetic or thermal or any other suitable type, for detecting pollutant impurities 42. The detector 16 performs the detection over the whole width of the entry slide 12 and signals the presence and position of impurities 42 to the control unit 32.

Immediately downstream of the entry slide 12 there is an inclined slide 20 suitable to feed the wood material towards a recovery device 11 of a known type, for example a recovery tank with water, if the wood material contains pollutant impurities 42, or towards the first collection device.

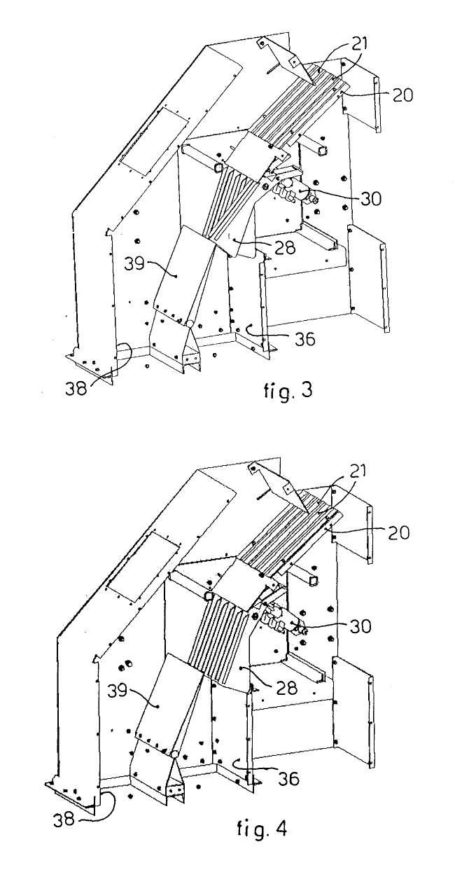

According to a characteristic feature of the invention, the separation device 26, disposed immediately downstream of the slide 20, comprises a plurality of mobile deflecting blades 28, reciprocally adjacent and mobile independently of each other. The deflecting blades 28 (FIGS. 1, 2, 3 and 4) are pivoted at one end so as to rotate, by a predefined angle, between a first position suitable for unloading the wood material selected into a first discharge channel 36, and a second position suitable for unloading the wood material incorporating the contaminating impurities 42 into a second discharge channel 38, separated by means of a wall 39, and suitable to expel them, for example towards a recovery tank 11 of a known type.

Each deflecting blade 28 is able to be driven individually by means of a relative actuator 30, of a known type, for example an electromagnetic actuator or a pneumatic device, commanded by the control unit 32.

The slide 20 comprises a plurality of sliding lanes 21, each associated with a relative deflecting blade 28, so as to channel the wood material into a plurality of sliding streams.

The apparatus 10 as described heretofore functions as follows.

The mass of wood-based incoherent material, comprising (FIGS. 1 and 2) wood elements 40 mixed with contaminating impurities 42, is unloaded onto the entry slide 12 and is subjected to control by the detector 16.

The deflecting blades 28 are initially disposed in their first position suitable for unloading the wood elements 40 towards the first discharge 36, to collect selected material.

When the detector 16 identifies a contaminating impurity 42, disposed in a predetermined transverse position on the entry slide 12, the detector 16 signals said presence to the control unit 32. In coordination with the speed of feed and with the transverse position on the slide 12 of the contaminating impurity 42, the control unit 32 activates the actuator 30, with a predetermined delay necessary for the feed of the contaminating impurity 42 to the relative deflecting blade 28, in order to drive the corresponding deflecting blade 28. The specific deflecting blade 28 is therefore disposed in its second position (FIG. 2) for the time necessary to impart a mechanical impact to the impurity 42 so as to deflect the motion of feed of the contaminating impurity 42 towards the second discharge channel 38.

Once the contaminating impurity 42 has been channeled into the desired seating, the specific deflecting blade 28 is again disposed in its first position.

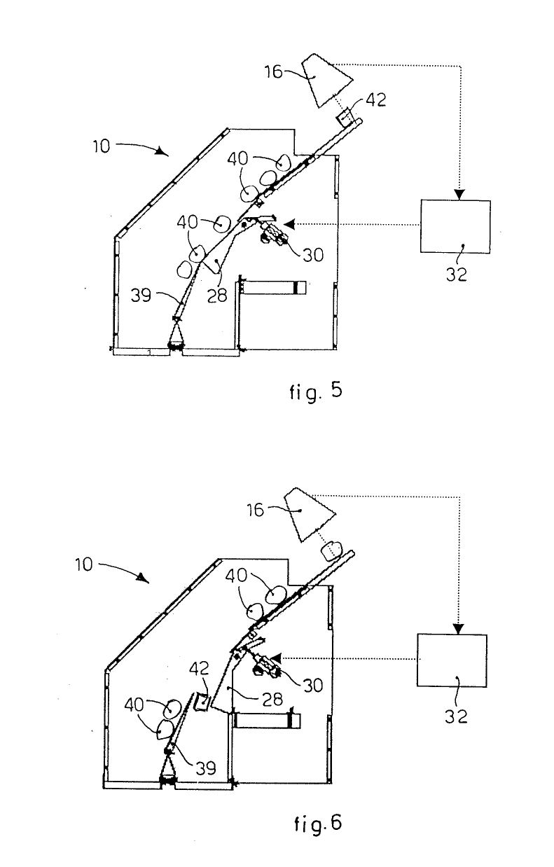

According to a variant shown in FIGS. 5 and 6, the second discharge channel is associated with the first collection device for the collection of selected material, while the first discharge channel 36 is associated with the recovery device. The deflecting blades 28 are normally disposed in the second position so as to channel the wood elements 40 towards the second discharge channel 38. When an impurity 42 is detected, disposed in a predetermined transverse position on the entry belt 12, the detector 16 signals it to the control unit 32. The control unit 32 activates the actuator 30, with a predetermined delay necessary for the feed of the contaminating impurity 42 to the relative deflecting blade 28, in order to drive the corresponding deflecting blade 28 which is disposed in its first position. The specific deflecting blade 28 (FIG. 6) disposed in its first position acts as a trapdoor, causing the impurity 42 to fall due to gravity into the first discharge channel 36, and then to the recovery device.

A second variant of the present invention is shown in FIG. 7, where the separation device 26 comprises a cylinder 27, rotary around a substantially horizontal axis of rotation and orthogonal to the direction of feed of the incoherent material to be subjected to cleaning. The cylinder 27 is maintained in rotation in a predetermined direction of rotation, in this case clockwise, by means of a motor of a known type and not shown in the drawings.

The cylinder 27 comprises on its lateral surface a plurality of separate pockets 33, suitable to collect the incoherent material arriving from the slide 12. The pockets 33 open radially towards the inside of the cylinder 27 and are also disposed in a regular structure which is repeated transversely on the lateral surface of the cylinder 27. In this way the pockets 33 are divided into groups according to the transverse position occupied on the lateral surface of the cylinder 27.

The separation device 26 also comprises a plurality of doors 128, each associated with a predetermined group of pockets 33. The doors 128 are mobile between a first position and a second position, driven by means of an actuator 30 commanded by the control unit 32. The doors 128 have a curvilinear structure so as to be coupled with the lateral surface of the cylinder 27 and to define, when disposed in the first position, a containing and/or closing profile for at least one pocket 33 disposed adjacent during the rotation of the cylinder 27.

According to this variant of the apparatus 10 the mass of incoherent wood-based material is checked by means of the detector 16 as it is fed at a known speed towards the separation device 26. The cylinder 27 is maintained in rotation at a predetermined or predeterminable speed according to the speed of feed of the mass of incoherent material and the doors 128 are maintained in their first closed position. In this way the mass of incoherent material without impurities is deposited continuously in the pockets 33 and subsequently discharged due to centrifugal effect and due to gravity towards the first collection device of selected material.

If the detector 16 identifies an impurity 42 disposed in a predetermined transverse position on the belt 12, the detector 16 signals the presence and the transverse position of said impurity 42 to the control unit 32. The impurity 42 is deposited in a pocket 33 associated with said transverse position of the impurity 42. In coordination with the speed of feed of the impurity 42 and the speed of rotation of the cylinder 27, the control unit 32 activates the actuator 30, with a predetermined delay, in order to drive the door 128 associated with the pocket 33 in which the impurity 42 is deposited. The door 128 is then disposed in its second position so as to allow the impurity 42 detected and contained in the specific pocket 33 to exit, due to the effect of gravity and of the centrifugal force of rotation of the cylinder 27. In this way the impurity 42 is diverted into the second discharge 38 towards the second collection device.

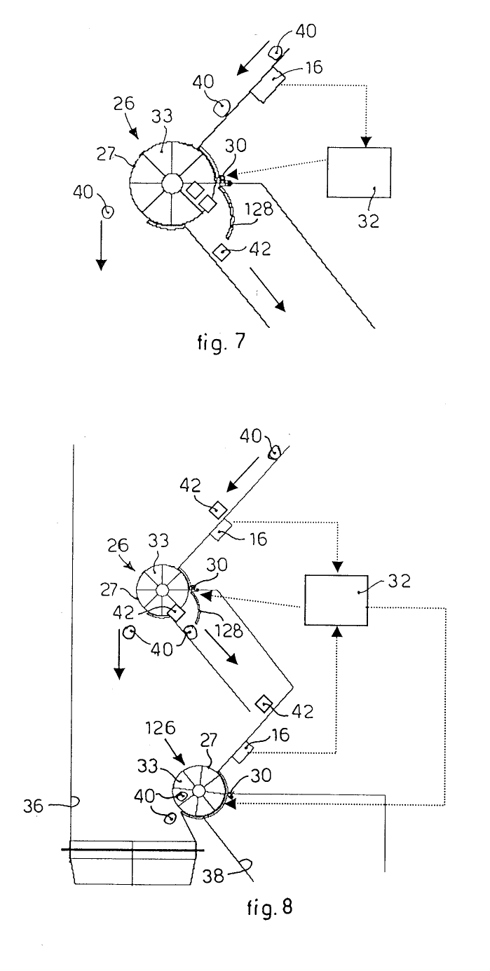

It is clear that modifications and/or additions of parts may be made to the apparatus as described heretofore, without departing from the field and scope of the present invention. For example, it comes within the field of the present invention to insert into the apparatus 10 a second separation device 126 (FIG. 8), disposed downstream of the first separation device 26, to make a further selection of the material discarded by the first separation device 26. The second separation device 126 can be smaller in size than the first apparatus 10, according to the reduced stream of incoherent material. Or the second separation device can be associated with a detector 16 suitable to separate a specific type of impurity, such as for example to separate different types of metal materials contained in the impurities discarded by the first separation device 26.

It is also clear that, although the present invention has been described with reference to some specific examples, a person of skill in the art shall certainly be able to achieve many other equivalent forms of an apparatus for separating impurities in masses of incoherent materials, having the characteristics as set forth in the claims and hence all coming within the field of protection defined thereby.

1. An apparatus for separating impurities in a mass of incoherent materials disposed on sliding means, the apparatus comprising:
a detection device, associated with said sliding means and a separation device,
wherein said separation device comprising a plurality of deflecting elements for removing, by means of a mechanical separation action and selective discharge, a portion of incoherent material comprising an impurity,
wherein each deflecting element is mobile between a first position for feeding incoherent material without impurities, and a second position for expelling incoherent material including an impurity, and
wherein said separation device comprises a cylinder rotary around a substantially horizontal axis of rotation and orthogonal to the direction of feed of incoherent material, said cylinder comprising a plurality of compartments, open on the lateral surface of the cylinder, associated with a predetermined deflecting element for collecting incoherent material unloaded from said sliding means.

2. (canceled)

3. The apparatus as in claim 1, wherein each deflecting element is driven to impart a mechanical impact to the portion of incoherent material including an impurity.

4. The apparatus as in claim 1, wherein each deflecting element is driven to cause the portion of incoherent material including an impurity to fall due to gravity.

5. (canceled)

6. The apparatus as in claim 1, wherein said deflecting element disposed in the second position thereof is able to selectively expel, to a collection device, incoherent material including impurities from a compartment of said cylinder disposed in proximity with said deflecting element, during the rotation of said cylinder.

7. The apparatus as in claim 6, wherein said deflecting element disposed in the first position thereof prevents the exit of incoherent material without impurities from a compartment of said cylinder disposed in proximity with said deflecting element, during the rotation of said cylinder.

8. (canceled)

9. The apparatus as in claim 1, wherein each deflecting element is able to be driven individually, in coordination with the speed of feed of said sliding means, and with the transverse position, with respect to the direction of feed of said sliding means, occupied by said impurities on said sliding means.

10. The apparatus as in claim 1, comprising a plurality of actuation means, each associated with a predetermined deflecting element and able to move said deflecting elements between the first position and the second position.

11. The apparatus as in claim 10, comprising a control and data processing unit, connected to said detection device and able to drive said actuation means.

12. The apparatus as in claim 1, wherein said sliding means comprises a plurality of feed lanes, each one associated with a deflecting element, and able to channel said masses of incoherent materials into a plurality of sliding streams.

13. The apparatus as in claim 12, wherein said sliding means comprises at least one member of the group consisting of a slide and a vibrating channel.

14. (canceled)

15. The apparatus as in claim 1, wherein said detection device comprises at least one member of the group consisting of an X-ray detector, a TV camera, an inductive sensor, a magnetic sensor, or a parasitic current sensor.

16-20. (canceled)

21. A method for separating impurities in masses of incoherent materials using an apparatus as in claim 1, and comprising the following steps:
a first step in which a mass of incoherent material is transported by means of sliding means associated with a detection device; and
a second step in which the mass of incoherent material is examined by said detection device to detect impurities in a predetermined position,
a third step in which the mass of incoherent material is fed towards a separation device comprising a plurality of adjacent deflecting elements mobile between a first position in which the incoherent material without impurities is made to advance, and a second position in which the incoherent material with impurities is expelled,
wherein the third step comprises feeding the incoherent material inside compartments of a rotating cylinder, and
wherein the material including an impurity as detected in the second step in expelled from the relative compartment of the cylinder by selectively moving said deflecting element in said second expulsion position.

22. The method as in claim 21, wherein in said third step a deflecting element associated with a lateral position of an impurity detected is moved from said first position to said second position with a predetermined delay with respect to the moment said impurity is detected by said detection device, said delay being correlated to the speed of feed of said sliding means.

23. The method as in claim 21, wherein in said second step the detection device signals the presence of an impurity to a control and data processing unit.

24. The method as in claim 23, wherein in said third step said control and data processing unit commands the activation of each deflecting element.
